(19) United States
(12) Patent Application Publication
(10) Pub. No.: US 2024/0264518 A1
(43) Pub. Date: Aug. 8, 2024

(54) POLARIZING ILLUMINATOR AND IMAGE PROJECTOR BASED THEREON

(71) Applicant: Meta Platforms Technologies, LLC, Menlo Park, CA (US)

(72) Inventor: Joshua Cobb, Victor, NY (US)

(21) Appl. No.: 18/106,980

(22) Filed: Feb. 7, 2023

(51) Int. Cl. G03B 21/20; G03B 21/00

(52) U.S. Cl. CPC G03B 21/2073; G03B 21/006; G03B 21/2033; G03B 21/2066; G03B 21/208; G02B 27/0172; G02B 2027/0178

(57) ABSTRACT

A polarizing illuminator with light recycling includes a light source and a reflector disposed proximate one another. An assembly including a lens, a quarter-wave plate, and a reflective polarizer is configured to redirect the light at unwanted polarization back to the specific location of the reflector, which reflects the light back through the quarter-wave plate, enabling the light to be recycled. The lens collimates both the transmitted and the recycled light portions, providing well-defined light beams. The configuration allows the recycled light beam to be collimated and to propagate in a pre-determined direction, allowing targeted focusing of the recycled light onto pixels of a spatial light modulator.

### TECHNICAL FIELD

The present disclosure relates to optical modules for providing illumination, and in particular to illuminators for visual display systems.

### BACKGROUND

Visual displays provide information to viewer(s) including still images, video, data, etc. Visual displays have applications in diverse fields including entertainment, education, engineering, science, professional training, advertising, to name just a few examples. Some visual displays, such as TV sets, display images to several users, while some visual display systems, such as near-eye displays (NEDs), are intended for individual users.

An artificial reality system generally includes an NED, e.g. a headset or a pair of glasses, configured to present content to a user. The NED may display virtual objects or combine images of real objects with virtual objects, as in virtual reality (VR), augmented reality (AR), or mixed reality (MR) applications. For example, in an AR/VR system, a miniature liquid crystal display may be used to provide images of virtual objects for observation by an eye of a user.

Because a display of HMD or NED is usually worn on user's head, a large, bulky, unbalanced, and/or heavy display device with a heavy battery would be cumbersome and uncomfortable for the user to wear. Consequently, light engines or image projectors used in NED systems need to be small end energy-efficient. Display systems based on an array of light valves, such as liquid crystal display panels, require compact and efficient light source that would illuminate the liquid crystal panels with a minimum loss of light due to polarization, vignetting, color mismatch, geometrical constraints, etc.

### BRIEF DESCRIPTION OF THE DRAWINGS

Exemplary embodiments will now be described in conjunction with the drawings, in which:

FIG. 1A is a schematic side view of a single-source polarizing illuminator of this disclosure;

FIG. 1B is a schematic side view of a polarization beamsplitter (PBS) embodiment of the single-source polarizing illuminator of FIG. 1A;

FIG. 2A is a schematic side view of an arrayed polarizing illuminator of this disclosure;

FIG. 2B is a top view of the arrayed polarizing illuminator of FIG. 2A;

FIG. 3 is a side cross-sectional view of a rendered optical model of the arrayed polarizing illuminator of FIG. 2A;

FIG. 4 is a schematic side view of an image projector including the arrayed polarizing illuminator of FIG. 2A and an optical system for illuminating a spatial light modulator (SLM) with two beam portions illuminating same pixels or pixel areas;

FIG. 5 is a simulated distribution of light energy at an intermediate plane within the optical system of FIG. 4;

FIGS. 6A and 6B are orthogonal side views of an embodiment of the image projector of FIG. 4 with a polarization-folded light path;

FIG. 7 is a flow chart of a method for recycling light in accordance with this disclosure;

FIG. 8 is a view of wearable display of this disclosure having a form factor of a pair of eyeglasses; and

FIG. 9 is a three-dimensional view of an HMD of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

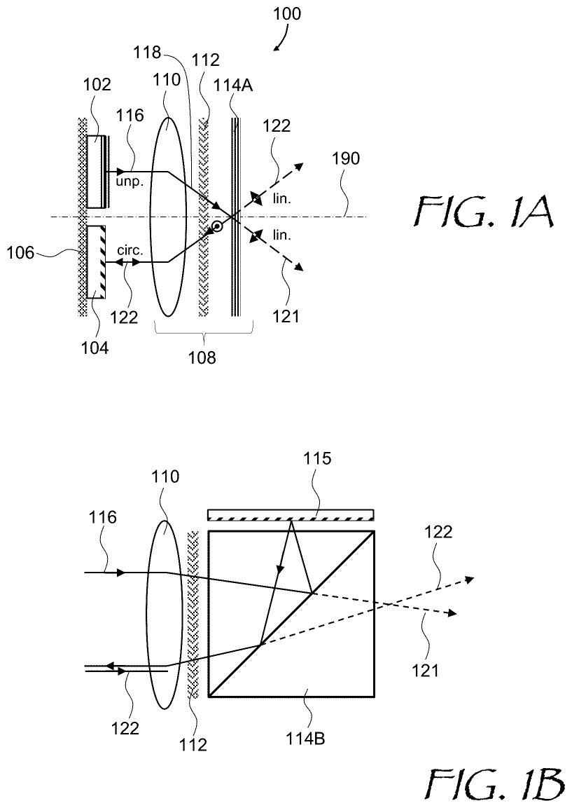

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1, 2A-2B, FIGS. 3 and 4, and FIGS. 6A-6B, similar reference numerals denote similar elements.

Unpolarized light sources, such as light-emitting diodes (LEDs), emit incoherent light suitable for illumination of display panels, as incoherent light does not cause interference fringing of the illuminating light. One non-limiting example of a display panel is a liquid crystal (LC) panel. LEDs may be used in combination with polarizers converting unpolarized light emitted by the LEDs into polarized light. Half of the light energy is lost when polarizing LED light with a regular transmissive polarizer, which absorbs light at the unwanted orthogonal polarization.

Polarization recycling configurations may use reflective polarizers that reflect light at the unwanted polarization back to a diffusing reflector or a light scatterer, which converts a portion of the reflected light back to the required polarization state by a series of random reflections by the reflector or random scattering by the scatterer. Any non-converted portion is reflected back, and so the process repeats until the reflected light energy is either absorbed by the reflector/scatterer or converted to the required polarization state. One drawback of polarization recycling is that a direction of propagation of the recycled light is not very well defined. The direction of propagation of the recycled light is random, causing the recycled light to behave much like scattered light. The scattered nature of the converted light impedes efficient utilization of the converted light for energy-efficient illumination of a display panel/spatial light modulator (SLM). Another drawback of polarization recycling is that the recycled light sometimes takes many passes through the recycling system because the polarization is not controlled well. The more cycles it takes the more light is absorbed, and the less efficient the system becomes.

In accordance with this disclosure, the energy of a light beam in a polarization state reflected by a reflective polarizer may be utilized more efficiently if the light path of the reflected light is pre-determined, pre-optimized, and/or pre-configured, such that the recycled light propagates through the reflective polarizer in a well-defined, well-directed state, similarly to a collimated or a nearly-collimated light beam. Such a configuration allows one to design the propagation path of the recycled light to selectively illuminate particular pixels or pixel groups of an SLM. For example, a same SLM pixel group or zone may be illuminated with recycled and non-recycled light beam portions at different angles of incidence.

The recovered or recycled light takes a single pass through the recycling optical train. The polarization is well controlled, so that it is not just a random polarization that allows a portion to be recycled and another portion to go through the recycling again. In a polarizing illuminator of this disclosure, the recycled light gets altered to the correct polarization at the first pass. The efficient, single-pass utilization of recycled collimated light beams improves the overall light utilization efficiency and wall plug efficiency of a visual display relying on a display panel/SLM to generate visual images.

In accordance with the present disclosure, there is provided a polarizing illuminator comprising a light source and a reflector proximate one another, and an assembly comprising a lens, a quarter-wave plate (QWP), and a reflective polarizer. The assembly is configured such that the lens collimates unpolarized light emitted by the light source to provide a collimated beam. The reflective polarizer receives the collimated beam transmits a first portion of the collimated beam in a first polarization state, and reflects a second portion of the collimated beam in a second, orthogonal polarization state. The second portion propagates back through the lens, gets focused by the lens onto the reflector, gets reflected by the reflector, propagates again through the lens, and gets re-collimated by the lens. The QWP is disposed between the light source and the reflective polarizer to convert the second portion to the first polarization state after the second portion is reflected by the reflector, to propagate through the reflective polarizer. The light source may include e.g. a semiconductor light source configured to emit unpolarized light, such as a light-emitting diode, for example.

The assembly may be configured to image the second portion of the collimated beam at a pre-determined location proximate the light source. A optical axis of the lens may be offset relative to the light source for focusing the second portion at the reflector. The second portion downstream of the reflective polarizer may have more than 50% of optical power of the first portion.

The reflector may be planar. The light source, the reflector, and the reflective polarizer may be disposed at a focal point of the lens. The polarizing illuminator may further include a support for supporting the light source. The reflector may be a portion of a reflective surface of the support proximate the light source. The reflective polarizer may include e.g. a wiregrid polarizer, a stack of films comprising birefringent materials, a stack of dielectric thin films, and/or a polarization beamsplitter optionally coupled to an auxiliary reflector.

In some embodiments, the assembly comprises a lens array including the lens mentioned above. The polarizing illuminator may further include an array of light sources including the abovementioned light source, and an array of reflectors including the abovementioned reflector. The assembly may be configured such that each lens of the lens array collimates unpolarized light emitted by a corresponding light source of the array of light sources to provide a collimated beam, the reflective polarizer receives each collimated beam transmits a first portion of each collimated beam in the first polarization state, and reflects a second portion of each collimated beam in the second polarization state. Each second portion propagates back through a corresponding lens of the lens array, gets focused by the corresponding lens onto a corresponding reflector of the array of reflectors, gets reflected by the corresponding reflector, propagates again through the corresponding lens, and gets re-collimated by that lens.

The QWP may be disposed between the array of light sources and the reflective polarizer to convert each second portion to the first polarization state after each second portion is reflected by the corresponding reflector, to propagate through the reflective polarizer. The arrays of light sources and reflectors may be interlaced with one another, such that a light source of the array of light sources is disposed between reflectors of the array of reflectors, and vice versa. The polarizing illuminator may further include a support for supporting the array of light sources, the support comprising a reflective surface. The array of reflectors may be formed by portions of the reflective surface between neighboring light sources of the array of light sources. The polarizing illuminator may further include an optical system for directing the first and second portions of each collimated beam onto a particular location at an array of pixels of a spatial light modulator.

In accordance with the present disclosure, there is provided an image processor comprising a polarizing illuminator described above, a spatial light modulator (SLM) comprising an array of pixels, and an optical system for directing the first and second portions of the collimated beams onto the array of pixels. In some embodiments, the optical system comprises an entrance pupil at the reflective polarizer and an exit pupil at the array of pixels and is configured to direct the first and second portions of each collimated beam at the entrance pupil onto a particular zone of the array of pixels at the exit pupil, each zone comprising a plurality of adjacent pixels of the array of pixels.

The optical system may include an optical path folded by polarization, and wherein the SLM comprises a liquid crystal panel. The optical system may include a pair of elements having optical power. The optical system may have a magnification magnitude ratio of one. In some embodiments, the image processor may further include a projection system downstream of the SLM for converting an image in linear domain displayed by the SLM into an image in angular domain.

In accordance with the present disclosure, there is further provided a method for recycling light. The method includes collimating unpolarized light emitted by a light source using a lens to obtain a collimated beam, propagating the collimated beam through a reflective polarizer to transmit a first portion of the collimated beam in a first polarization state and to reflect a second portion of the collimated beam in a second, orthogonal polarization state, focusing the reflected second portion at a pre-determined location proximate the light source, and reflecting the focused second portion using a reflector at the pre-determined location, re-collimating the second portion reflected by the reflector, converting a polarization state of the second portion from the second to the first polarization state, and transmitting the second portion in the first polarization state through the reflective polarizer. The method may further include directing or imaging the first and second portions onto a same zone of a spatial light modulator.

The light recycling method may be implemented for an array of light sources. Such a method may include collimating unpolarized light emitted by each light source of the array of light sources using an array of lenses including the abovementioned lens to obtain an array of collimated beams including the abovementioned collimated beam, propagating the collimated beams through the reflective polarizer to transmit first portions of the collimated beams in the first polarization state while reflecting second portions of the collimated beams in the second polarization state, focusing the reflected second portions onto reflectors disposed proximate corresponding light sources of the array of light sources, re-collimating the second portions reflected by the reflectors, converting the polarization state of the second portions from the second to the first polarization state, and transmitting the second portions in the first polarization state through the reflective polarizer.

Referring now to FIG. 1A, a polarizing illuminator 100 includes a light source 102, e.g. a semiconductor light source such as a light-emitting diode (LED) or a superluminescent light-emitting diode (SLED), and a reflector 104, e.g. a metallic reflector, a dielectric coating, etc., disposed at a pre-defined location proximate the light source 102. The reflector 104 may be planar as shown, or curved. The light source 102 and the reflector 104 may be supported by a support or substrate 106; the reflector 104 may be merely a reflective coating of the substrate 106 proximate the light source 102.

The polarizing illuminator 100 further includes an assembly 108 of the following optically coupled optical elements: a lens 110, a quarter-wave plate (QWP) 112, and a reflective polarizer 114A. The lens 110 may be e.g. a refractive lens, a plano-convex or a biconvex microlens, a diffractive lens or optical element, etc. The lens 110 may include any optical element having optical power, i.e. focusing/defocusing power. The QWP 112 converts linearly polarized light into a circularly polarized light at a wavelength of the light source 102. The QWP 112 may be a zero-order waveplate, or a multiple order achromatic waveplate. The QWP 112 may be disposed in an optical path anywhere between the reflective polarizer and the light source 102/reflector 104. For example, the QWP 112 could be disposed between the light source 102/reflector 104 and the lens 110, although the placement of the QWP 112 into a collimated light beam allows a better polarization control. The reflective polarizer 114A may be e.g. a wiregrid polarizer a stack of films comprising birefringent materials, such as the Advanced Polarizing Film from 3M Corporation from Maryland, USA, and/or a stack of dielectric thin films. Alternately, the waveplate and reflective polarizer may be replaced by a cholesteric liquid crystal layer.

In operation, the light source 102 emits unpolarized light 116, marked by “unp.” in FIG. 1A. The lens 110 receives the unpolarized light 116 and converts the unpolarized light 116 into a collimated beam with a field angle 118. To that end, the light source 102 may be disposed at the front focal point of the lens 110. The collimated beam 118 propagates through the QWP 112 and impinges onto the reflective polarizer 114A, which transmits a first portion 121 of the collimated beam 118 in a first polarization state, e.g. a linear polarization in plane of FIG. 1, and reflects a second portion 122 of the collimated beam 118 in a second, orthogonal polarization state, e.g. a linear polarization perpendicular to the plane of FIG. 1A. The second portion 122 of the collimated beam 118 propagates back through the QWP 112, the lens 110, and gets focused by the lens 110 onto the reflector 104, so that there is an image of light source 102 at the mirror surface 104 and the image is approximately the same size as the object. An optical axis 190 of the lens 110 may be offset relative to the light source 102 for focusing the second portion 122 at the reflector 104, which is offset relative to the light source 102 (offset vertically in FIG. 1A). Alternatively or in addition, the reflective polarizer 114A may be tilted to achieve the same goal.

The reflective polarizer 114A may be disposed at the rear focal point of the lens 110, which ensures that the circularly polarized second portion impinges, and reflects from, the reflector 104 in a telecentric fashion with the chief ray at a normal angle of incidence to the reflector 104. Such a telecentric configuration, when the light source 102 and the reflector 104 are placed at the focal point of the lens 110 on one side of the lens 110, and the reflective polarizer 114A at the focal point of the lens 110 on the other side of the lens 110, lessens vignetting in the optical system, allowing one to increase overall optical throughput.

After propagation through the QWP 112, the second portion 122 becomes circularly polarized, as denoted with “circ.” in FIG. 1A. The circularly polarized second portion 122 of the collimated beam 118 gets reflected by the reflector 104, which changes the handedness of the circular polarization, propagates again through the lens 110, which re-collimates the second portion 122 of the collimated beam 118. Then, the circularly polarized second portion 122 propagates through the QWP 112, which converts its polarization to the first polarization state, allowing the second portion 122 to propagate through the reflective polarizer 114A. Thus, substantially all the unpolarized light 116 gets polarized by the assembly 108 on a single pass of the recycled light, not counting losses caused by cropping/vignetting or absorbing light or Fresnel reflections. Such a configuration facilitates a very efficient single-pass light energy recycling; for example, the second portion downstream of the reflective polarizer may have more than 50% of optical power of the first portion, which is unattainable with scatterer-based light recycling methods. In contradistinction with an approach where the reflected light is scattered and/or randomly reflected by a diffusing reflector, a reflective cavity, a scatterer, etc., the assembly 108 is configured to focus the second portion 122 of the collimated beam 118 at a pre-determined location proximate the light source 102, enabling a well-collimated recycled light beam to be formed. The first 121 and second 122 portions of the collimated beam 118 may be directed onto an entire SLM or a portion of the SLM using an imaging or projecting system, not shown for brevity.

The reflective polarizer 114A of FIG. 1A of the polarizing illuminator 100 is a planar reflective polarizer. Referring to FIG. 1B with further reference to FIG. 1A, the planar the reflective polarizer 114A may be replaced with a combination of a polarization beamsplitter (PBS) 114B and an auxiliary reflector 115. In operation, the unpolarized light 116 gets collimated by the lens 110. The first light portion 121 in the first polarization state propagates through the PBS 114B, and the second light portion 122 in the second polarization state gets reflected by the PBS 114B towards the auxiliary reflector 115, which sends the second portion 122 to propagate back to the PBS 114B. The second portion 122 is reflected again by the PBS 114B with an offset (downwards in FIG. 1B), and gets re-focused by the lens 110 onto the reflector 104, not shown in FIG. 1B. Then, the polarization of the second portion 122 is changed to the first polarization state in a similar manner as in the polarizing illuminator 100 of FIG. 1A, causing the second portion 122 to propagate through the PBS 114B at a different angle from the first portion 121. In some embodiments, the auxiliary polarizer 115 may be a reflective coating on the top surface of the PBS 114B. In a similar manner, the QWP 112 may be laminated onto the left (upstream) surface of the PBS 114B.

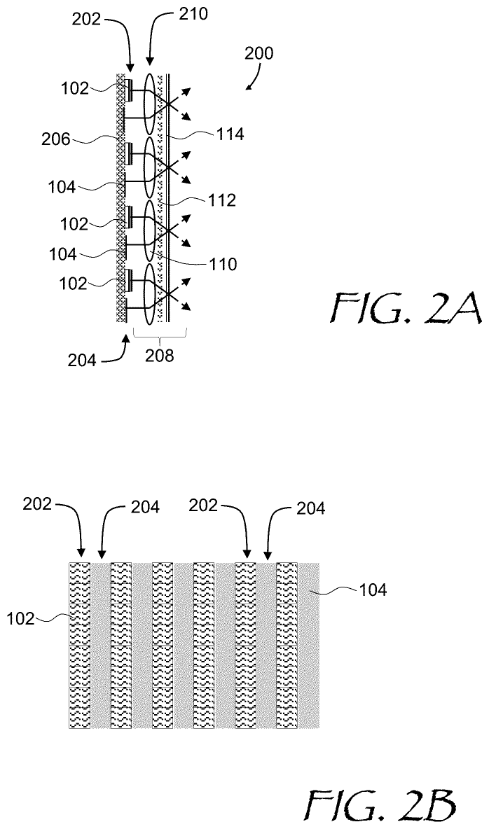

Referring now to FIGS. 2A and 2B with a further reference to FIGS. 1A and 1B considered above, a polarizing illuminator 200 is an arrayed embodiment of the polarizing illuminator 100 of FIG. 1A. The polarizing illuminator 200 includes not just one light source 102 but an array 202 of the light sources 102, including the light source 102 of FIG. 1A, e.g. a LED and/or SLED array. The polarizing illuminator 200 includes not just one reflector 104 but an array 204 of the reflectors 104 including the reflector 104 of FIG. 1A, e.g. dielectric and/or metallic reflective coatings.

The polarizing illuminator 200 of FIG. 2A further includes an assembly 208. The assembly 208 has not just one lens 110 but an array 210 of the lenses 110, e.g. a plano-convex or a biconvex microlens array, including the lens 110 of FIG. 1A. In the embodiment shown, the polarizing illuminator 200 includes a reflective support 206 supporting the array of light sources 202. The array of reflectors 204 may be formed by portions of a surface of the reflective support 206 between neighboring light sources 202 of the array of light sources 202. As seen in FIG. 2B, the arrays 202, 204 of light sources and reflectors respectively are interlaced or interdigitated with one another, such that a light source of the array is disposed between reflectors of the array of reflectors, and vice versa. Other interlaced configurations are possible.

The operation of the arrayed polarizing illuminator 200 of FIGS. 2A and 2B is similar to that of a single-source polarizing illuminator 100 of FIG. 1A. Each lens 110 of the lens array 210 collimates unpolarized light emitted by a corresponding light source 102 of the light source array 202 to provide a corresponding collimated beam that propagates through the QWP 112. The reflective polarizer 114A receives each collimated beam propagated through the QWP 112, transmits a first portion of each collimated beam in the first polarization state, and reflects a second portion of each collimated beam in the second polarization state. Each second portion propagates back through the QWP 112, the corresponding lens 110 of the array 210, gets focused by the corresponding lens 110 onto a corresponding reflector 104 of the array 204 of reflectors, gets reflected by the corresponding reflector 104, propagates again through the corresponding lens 110 of the lens array 210, gets re-collimated by the corresponding lens 110, propagates through the QWP 112 converting the second polarization state into the first polarization state, and propagates through the reflective polarizer 114A. The QWP 112 may be disposed at other locations between the light source 102/reflector 104, on one hand, and the reflective polarizer 114A, on the other, for converting the second portion 122 to the first polarization state after the second portion 122 is reflected by the reflector 104, to propagate through the reflective polarizer 114A. In some embodiments, the reflective polarizer 114A may be replaced with a PBS 114B, or an array of PBS 114B.

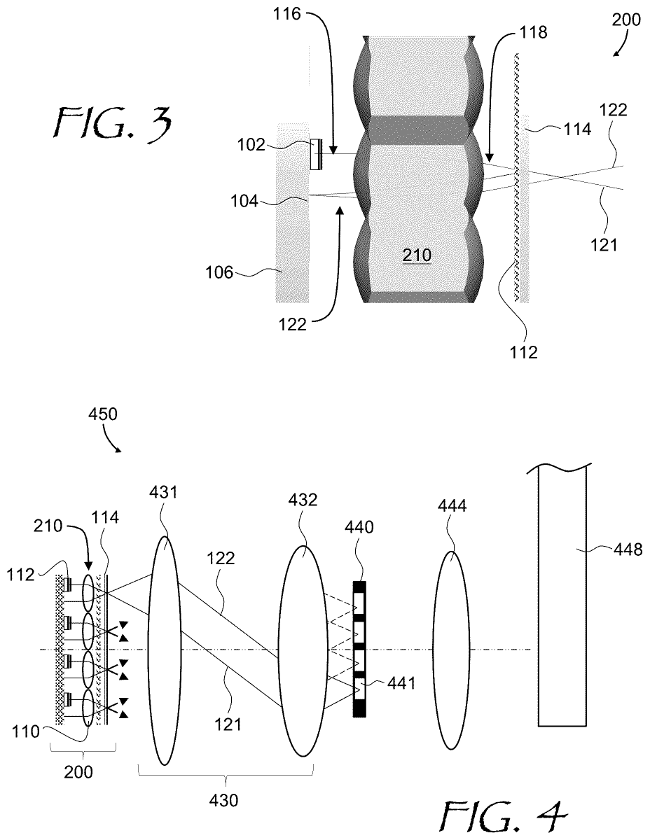

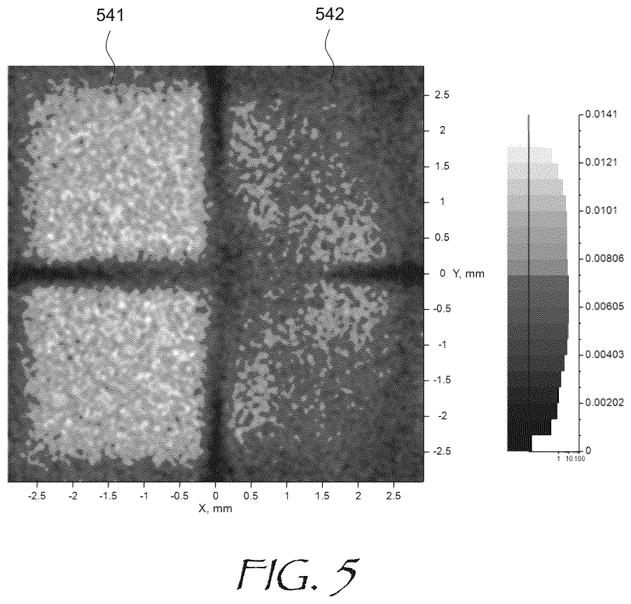

The operation of the arrayed polarizing illuminator 200 of FIGS. 2A and 2B is further illustrated in FIG. 3. The light source 102 of the array 202 of light sources emits the unpolarized light 116, which is collimated by a lens of the lens array 210, in this example an array of biconvex refractive microlenses. The collimated beam 118 propagates through the QWP 112 and impinges onto the reflective polarizer 114A, which transmits the first portion 121 of the collimated beam 118 in the first polarization state and reflects the second portion 122 of the collimated beam 118 in the second polarization state orthogonal to the first polarization state. The first and second polarization states may be orthogonal linear polarization states or circular polarization states with opposite handedness, for example.

The second portion 122 of the collimated beam 118 propagates back through the QWP 112 and the lens 110, getting focused by the lens 110 onto the reflector 104, in this case a reflective surface of the substrate/support 106. After propagation through the QWP 112, the second portion 122 becomes circularly polarized, which changes handedness of the circular polarization upon reflecting from the reflector 104. Then, the circularly polarized second portion 122 propagates through the QWP 112, which converts its polarization to the first polarization state, causing the second portion 122 to propagate through the reflective polarizer 114A.

Turning to FIG. 4, an image projector 450 is configured to illuminate a display panel/SLM, or a portion of the display panel/SLM, with the two polarized beam portions 121, 122 at different beam angles. The image projector 450 includes the arrayed polarizing illuminator 200 of FIGS. 2A, 2B, and FIG. 3, and an SLM 440 having an array of pixels, including a first pixel 441. An optical system 430, also termed illumination condensing system, includes first 431 and second 432 elements having optical power, such as lenses and/or curved mirrors. In the example illustrated in FIG. 4, the first 431 and second 432 elements are convex lenses disposed to direct the first 121 and second 122 portions of the collimated beam 118 onto the first pixel 441 at different angles of incidence. Each pixel of the SLM 440, or in some embodiments, each zone or pixel area including a plurality of adjacent pixels of the SLM 440, is illuminated by a particular pair of the first 121 or second 122 portions of a particular light beam emitted by one of the light sources 102 and collimated by one of the lenses 110.

The operation of the optical system 430 may be explained in terms of conjugate optical planes of the optical system 430. An entrance pupil of the optical system 430 is located at the front focal plane of the first element 431 where the collimated beams cross the optical axes of the lens 110 of the lens array 210, i.e. at the reflective polarizer 114A. This entrance pupil has light of the original and recycled polarizations on top of each other, at different beam angles. The entrance pupil is conjugated by the optical system 430 into an exit pupil where the light of two polarizations is also overlapped. The exit pupil is disposed at the SLM 440. In some embodiments, the optical system 430 may be telecentric and/or have a magnification magnitude ratio of one.

Using polarization-recycled light provides considerable savings of the illuminating light energy. Furthermore, addressing different light sources 102 of the arrayed polarizing illuminator 200 individually allows zonal illumination of the SLM 440. Turning off one or more of the light sources 102 in areas of low brightness of the displayed image allows one to save energy and increase overall contrast of the displayed image.

The image projector 450 may further include a projection system 444, such as a refractive, reflective, and/or pancake lens, disposed downstream of the SLM 440. The purpose of the projection system 444 is to convert an image in linear domain displayed by the SLM 440 into an image in angular domain. Herein, the term “image in linear domain” means an image where individual pixels (elements of the image) are represented by corresponding ray coordinates, and the term “image in angular domain” means an image where individual pixels are represented by corresponding ray angles. Thus, the function of the projection system 444 is to operate as an “offset-to-angle” element converting ray coordinate, i.e. a pixel coordinate of the SLM 440, into ray angle downstream of the projection system 444. The image in angular domain may be observed by a viewer's eye directly, or via an optional pupil-replicating lightguide 448 that operates to expand the exit pupil of the image projector 450 by in-coupling the image light carrying an image in angular domain and out-coupling laterally offset portions of the image light while preserving its angular distribution, or in other words preserving the image to be displayed.

The zonal illumination of the SLM 440 with the original and recycled light is further illustrated in FIG. 5, which shows light energy distribution at an intermediate plane between the first 431 and second 432 elements. First areas 541 correspond to the directly transmitted light and second areas 542 correspond to the recycled light. The first 541 and second 542 areas are offset from one another since the first 121 and second 122 beam portions are offset between the first 431 and second 432 elements in FIG. 4. Each pixel or zone at the SLM 440 have such optical energy distribution, only in angular domain. In other words, a portion of the light cone illuminating a particular zone or pixel is provided by the directly transmitted light corresponding to the first beam portion 121, and another, complementary portion of the illuminating light cone is provided by the recycled light corresponding to the second beam portion 122. In this proof-of-concept verification example, the recycled light of the second beam portion 122 is about 75-80% of the light energy of the originally transmitted light of the first beam portion 121, corresponding to the energy utilization improvement of 75-80%.

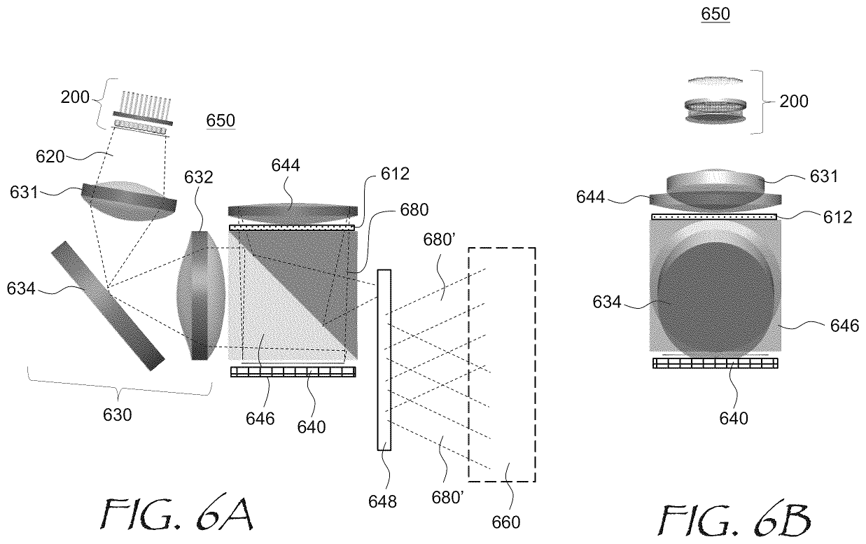

Turning to FIGS. 6A and 6B, an image projector 650 has an optical configuration of the image projector 450 of FIG. 4 with an optical path folded by polarization. Specifically, the image projector 650 of FIGS. 6A and 6B includes the arrayed polarizing illuminator 200 of FIGS. 2A, 2B, and FIG. 3, a reflective SLM 640 such as a liquid crystal on silicon (LCoS) device, an optical system 630 comprising first 631 and second 632 lenses and a folding mirror 634, and a polarization beamsplitter (PBS) 646 for folding the light path by polarization. The image projector 650 further includes an image projection assembly 644 and a pupil-replicating lightguide 648.

In operation, the arrayed polarizing illuminator 200 produces an array of first beam portions of illuminating light propagated through the reflective polarizer of the polarizing illuminator 200 on the first pass, and an array of second beam portions of illuminating light 620, which are recycled beam portions. The optical system 630 directs the first and second beam portions collimated by a same microlens of the arrayed polarizing illuminator 200 onto a same portion or zone of the reflective SLM 640. Thus, the optical system 630 may operate as a zonal illumination condensing system.

The illuminating light 620 has the first polarization state, and the PBS 646 is configured to reflect light in the first polarization state towards the reflective SLM 640. The reflective SLM 640, e.g. a liquid crystal on silicon (LCoS) SLM, modulates the light in polarization, which is converted into amplitude modulation upon propagation through the PBS 646, providing image light 680 carrying an image in linear domain to be displayed to a user. The image in linear domain is converted into an image in angular domain by the image projection assembly 644, which operates as an offset-to-angle element. In the embodiment shown, the image projection assembly 644 includes refractive and reflective elements in a so-called birdbath configuration. A QWP 612 may be placed between the PBS 646 and the image projection assembly 644 for converting between two orthogonal polarizations on double pass for folding optical path by polarization.

The image light 680 is directed to the pupil-replicating lightguide 648 (shown in FIG. 6A only), which replicates the image light 680, producing a plurality of laterally offset portions 680′ of the image light 680 for uniform illumination of an eyebox 660.

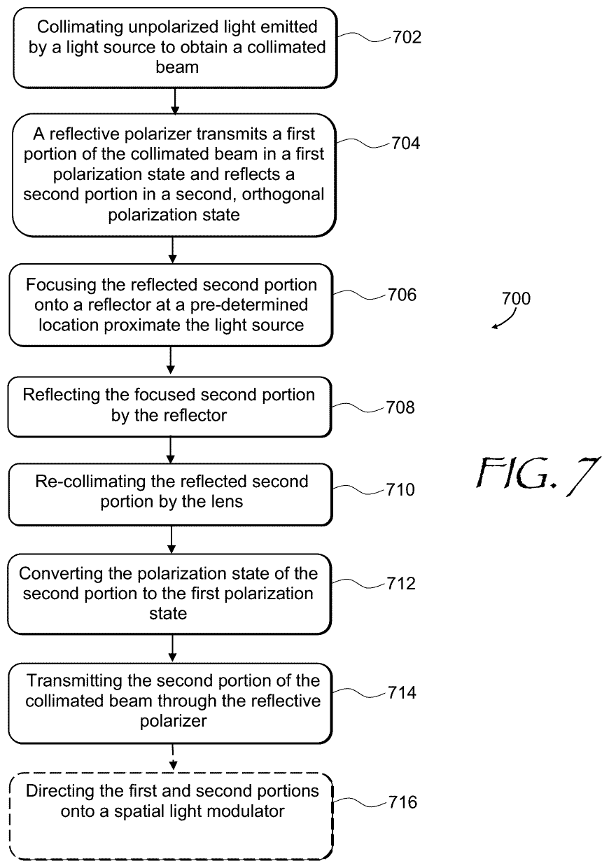

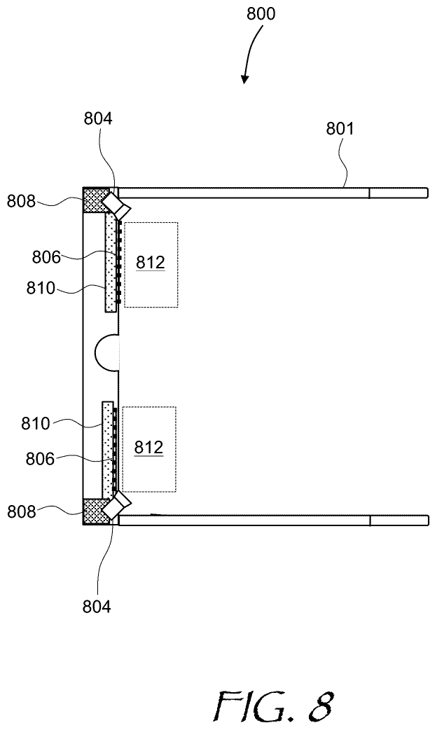

Turning now to FIG. 7 with further reference to FIGS. 1 and 2A, a method 700 (FIG. 7) for recycling light includes collimating (702) unpolarized light emitted by a light source using a lens, for example collimating the unpolarized light 116 by the lens 110 (FIG. 1A) to obtain a collimated beam, e.g. the collimated beam 118 in FIG. 1A. The collimated beam is propagated (FIG. 7; 704) through a reflective polarizer, e.g. the reflective polarizer 114A, to transmit a first portion of the collimated beam in a first polarization state and to reflect a second portion of the collimated beam in a second, orthogonal polarization state. The reflected second portion is focused (706) onto a reflector disposed at a pre-determined location proximate the light source. The focused second portion is reflected (708) by the reflector at the pre-determined location and re-collimated by the lens (710). A polarization state of the second portion is converted (712) from the second to the first polarization state, allowing the second portion to be transmitted (714) through the reflective polarizer. The polarization state conversion may be afforded by a double propagation through a QWP and one reflection from the reflector.

The pre-determined position and direction of propagation of the recycled light represented by the second portion of the collimated beam allows one to direct (716) the first and second portions onto a spatial light modulator. The first and second portions may be directed onto a same pixel at different angles of incidence, as explained above with reference to FIG. 4.

In an arrayed illumination embodiment of the method 700, light emitted by not one but an array of light sources may be recycled. In the arrayed illumination embodiment, the collimating 702 of the unpolarized light includes collimating unpolarized light emitted by each light source of the array of light sources, e.g. the array 202 of light sources 102 (FIG. 2A), using an array of lenses such as the lens array 210, to obtain an array of collimated beams. The propagation (FIG. 7; 704) of the collimated beams through the reflective polarizer includes transmitting the first portions of the collimated beams in the first polarization state while reflecting second portions of the collimated beams in the second polarization state. The focusing 706 includes focusing the reflected second portions onto reflectors disposed proximate the corresponding light sources by corresponding lenses. The reflecting 708 includes the reflecting of the second portions by the reflectors, and the re-collimating 710 includes re-collimating all second portions. The second portions are converted (712) to the first polarization state, and are transmitted (714) through the reflective polarizer, to optionally be directed (716) onto the SLM, e.g. pixel-by-pixel or zone-by-zone as explained above with reference to FIG. 4.

Turning to FIG. 8, an augmented reality (AR) near-eye display 800 includes a frame 801 having a form factor of a pair of eyeglasses. The frame 801 supports, for each eye: a projector 808 including any image projector described herein, a pupil-replicating waveguide 810 optically coupled to the projector 808, an eye-tracking camera 804, a plurality of illuminators 806, and an eye-tracking camera controller. The illuminators 806 may be supported by the pupil-replicating waveguide 810 for illuminating an eyebox 812. The projector 808 provides a fan of light beams carrying an image in angular domain to be projected into a user's eye. The pupil-replicating waveguide 810 receives the fan of light beams and provides multiple laterally offset parallel copies of each beam of the fan of light beams, thereby extending the projected image over the eyebox 812.

For AR applications, the pupil-replicating waveguide 810 can be transparent or translucent to enable the user to view the outside world together with the images projected into each eye and superimposed with the outside world view. The images projected into each eye may include objects disposed with a simulated parallax, so as to appear immersed into the real world view.

The purpose of the eye-tracking cameras 804 is to determine position and/or orientation of both eyes of the user. Once the position and orientation of the user's eyes are known, a gaze convergence distance and direction may be determined. The imagery displayed by the projectors 808 may be adjusted dynamically to account for the user's gaze, for a better fidelity of immersion of the user into the displayed augmented reality scenery, and/or to provide specific functions of interaction with the augmented reality.

In operation, the illuminators 806 illuminate the eyes at the corresponding eyeboxes 812, to enable the eye-tracking cameras to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with illuminating light, the latter may be made invisible to the user. For example, infrared light may be used to illuminate the eyeboxes 812.

The function of the eye-tracking camera controllers is to process images obtained by the eye-tracking cameras 804 to determine, in real time, the eye gazing directions of both eyes of the user. In some embodiments, the image processing and eye position/orientation determination functions may be performed by a central controller, not shown, of the AR near-eye display 800. The central controller may also provide control signals to the projectors 808 to generate the images to be displayed to the user, depending on the determined eye positions, eye orientations, gaze directions, eyes vergence, etc.

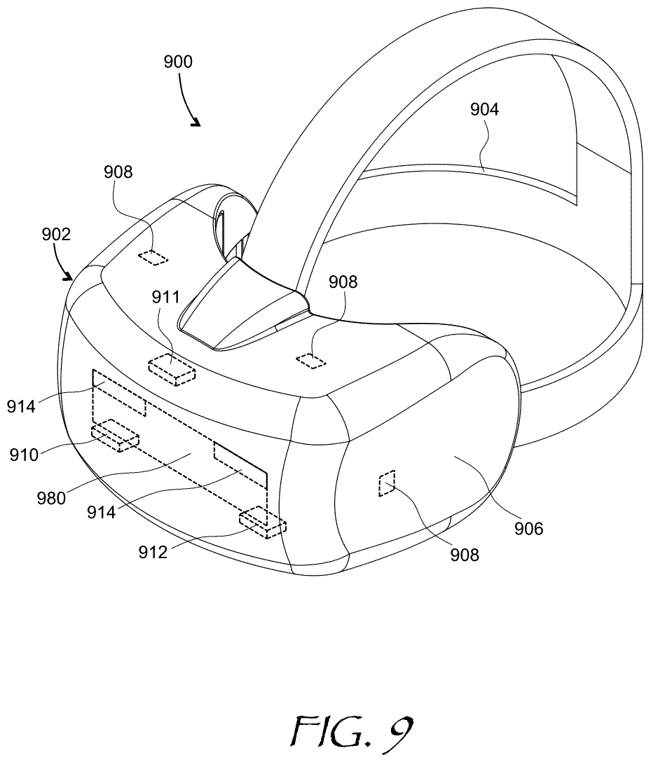

Turning to FIG. 9, an HMD 900 is an example of an AR/VR wearable display system which encloses the user's face, for a greater degree of immersion into the AR/VR environment. The HMD 900 may generate the entirely virtual 3D imagery. The HMD 900 may include a front body 902 and a band 904 that can be secured around the user's head. The front body 902 is configured for placement in front of eyes of a user in a reliable and comfortable manner. A display system 980 may be disposed in the front body 902 for presenting AR/VR imagery to the user. The display system 980 may include any of the image projectors disclosed herein. Sides 906 of the front body 902 may be opaque or transparent.

In some embodiments, the front body 902 includes locators 908 and an inertial measurement unit (IMU) 910 for tracking acceleration of the HMD 900, and position sensors 912 for tracking position of the HMD 900. The IMU 910 is an electronic device that generates data indicating a position of the HMD 900 based on measurement signals received from one or more of position sensors 912, which generate one or more measurement signals in response to motion of the HMD 900. Examples of position sensors 912 include: one or more accelerometers, one or more gyroscopes, one or more magnetometers, another suitable type of sensor that detects motion, a type of sensor used for error correction of the IMU 910, or some combination thereof. The position sensors 912 may be located external to the IMU 910, internal to the IMU 910, or some combination thereof.

The locators 908 are traced by an external imaging device of a virtual reality system, such that the virtual reality system can track the location and orientation of the entire HMD 900. Information generated by the IMU 910 and the position sensors 912 may be compared with the position and orientation obtained by tracking the locators 908, for improved tracking accuracy of position and orientation of the HMD 900. Accurate position and orientation is important for presenting appropriate virtual scenery to the user as the latter moves and turns in 3D space.

The HMD 900 may further include a depth camera assembly (DCA) 911, which captures data describing depth information of a local area surrounding some or all of the HMD 900. The depth information may be compared with the information from the IMU 910, for better accuracy of determination of position and orientation of the HMD 900 in 3D space.

The HMD 900 may further include an eye tracking system 914 for determining orientation and position of user's eyes in real time. The obtained position and orientation of the eyes also allows the HMD 900 to determine the gaze direction of the user and to adjust the image generated by the display system 980 accordingly. The determined gaze direction and vergence angle may be used to adjust the display system 980 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 902.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A polarizing illuminator comprising:
a light source and a reflector proximate one another; and
an assembly comprising a lens, a quarter-wave plate (QWP), and a reflective polarizer,
wherein the assembly is configured such that:
the lens collimates unpolarized light emitted by the light source to provide a collimated beam;
the reflective polarizer receives the collimated beam transmits a first portion of the collimated beam in a first polarization state, and reflects a second portion of the collimated beam in a second, orthogonal polarization state; and
the second portion propagates back through the lens, gets focused thereby onto the reflector, gets reflected thereby, propagates again through the lens, and gets re-collimated thereby;
wherein the QWP is disposed between the light source and the reflective polarizer to convert the second portion to the first polarization state after the second portion is reflected by the reflector, to propagate through the reflective polarizer.

2. The polarizing illuminator of claim 1, wherein the assembly is configured to image the second portion of the collimated beam at a pre-determined location proximate the light source.

3. The polarizing illuminator of claim 1, wherein an optical axis of the lens is offset relative to the light source for focusing the second portion at the reflector.

4. The polarizing illuminator of claim 1, wherein the second portion downstream of the reflective polarizer has more than 50% of optical power of the first portion.

5. The polarizing illuminator of claim 1, wherein at least one of:
the reflector is planar; or
the light source, the reflector, and the reflective polarizer are disposed at a focal point of the lens.

6. The polarizing illuminator of claim 1, wherein the light source comprises a semiconductor light source configured to emit unpolarized light.

7. The polarizing illuminator of claim 1, further comprising a support for supporting the light source, wherein the reflector is a portion of a reflective surface of the support proximate the light source.

8. The polarizing illuminator of claim 1, wherein the reflective polarizer comprises at least one of: a wiregrid polarizer; a stack of films comprising birefringent materials; a stack of dielectric thin films; or a polarization beamsplitter.

9. The polarizing illuminator of claim 1, wherein the assembly comprises a lens array including the lens, the polarizing illuminator further comprising:
an array of light sources including the light source; and
an array of reflectors including the reflector;
wherein the assembly is configured such that:
each lens of the lens array collimates unpolarized light emitted by a corresponding light source of the array of light sources to provide a collimated beam;
the reflective polarizer receives each collimated beam transmits a first portion of each collimated beam in the first polarization state, and reflects a second portion of each collimated beam in the second polarization state; and
each second portion propagates back through a corresponding lens of the lens array, gets focused by the corresponding lens onto a corresponding reflector of the array of reflectors, gets reflected by the corresponding reflector, propagates again through the corresponding lens, and gets re-collimated thereby;
wherein the QWP is disposed between the array of light sources and the reflective polarizer to convert each second portion to the first polarization state after each second portion is reflected by the corresponding reflector, to propagate through the reflective polarizer.

10. The polarizing illuminator of claim 9, wherein the arrays of light sources and reflectors are interlaced with one another, such that a light source of the array of light sources is disposed between reflectors of the array of reflectors, and vice versa.

11. The polarizing illuminator of claim 9, further comprising a support for supporting the array of light sources, the support comprising a reflective surface, wherein the array of reflectors is formed by portions of the reflective surface between neighboring light sources of the array of light sources.

12. The polarizing illuminator of claim 9, further comprising an optical system for directing the first and second portions of each collimated beam onto a particular location at an array of pixels of a spatial light modulator.

13. An image projector comprising:
a polarizing illuminator comprising:
an array of light sources and an array of reflectors interlaced with the light sources, such that a light source of the array is disposed between reflectors of the array of reflectors, and vice versa;
an assembly comprising an array of lenses, a quarter-wave plate (QWP), and a reflective polarizer, wherein the assembly is configured such that:
each lens of the lens array collimates unpolarized light emitted by a corresponding light source of the array of light sources to provide a collimated beam;
the reflective polarizer transmits a first portion of each collimated beam in a first polarization state and reflects a second portion of each collimated beam in a second, orthogonal polarization state;
each second portion propagates back through the corresponding lens, gets focused thereby onto a corresponding reflector of the array of reflectors, gets reflected by the corresponding reflector, propagates again through the corresponding lens, and gets re-collimated thereby;
wherein the QWP is disposed between the light source and the reflective polarizer to convert each second portion to the first polarization state after each second portion is reflected by the corresponding reflector, to propagate through the reflective polarizer;
a spatial light modulator (SLM) comprising an array of pixels; and
an optical system for directing the first and second portions of the collimated beams onto the array of pixels.

14. The image projector of claim 13, wherein the optical system comprises an entrance pupil at the reflective polarizer and an exit pupil at the array of pixels and is configured to direct the first and second portions of each collimated beam at the entrance pupil onto a particular zone of the array of pixels at the exit pupil, each zone comprising a plurality of adjacent pixels of the array of pixels.

15. The image projector of claim 13, wherein the optical system comprises an optical path folded by polarization, and wherein the SLM comprises a liquid crystal panel.

16. The image projector of claim 13, wherein at least one of:
the optical system comprises a pair of elements having optical power; or
the optical system has a magnification magnitude ratio of one.

17. The image projector of claim 13, further comprising a projection system downstream of the SLM for converting an image in linear domain displayed by the SLM into an image in angular domain.

18. A method for recycling light, the method comprising:
collimating unpolarized light emitted by a light source using a lens to obtain a collimated beam;
propagating the collimated beam through a reflective polarizer to transmit a first portion of the collimated beam in a first polarization state and to reflect a second portion of the collimated beam in a second, orthogonal polarization state;
focusing the reflected second portion at a pre-determined location proximate the light source, and reflecting the focused second portion using a reflector at the pre-determined location;
re-collimating the second portion reflected by the reflector;
converting a polarization state of the second portion from the second to the first polarization state; and
transmitting the second portion in the first polarization state through the reflective polarizer.

19. The method of claim 18, further comprising imaging the first and second portions onto a same zone of a spatial light modulator.

20. The method of claim 18 for recycling light emitted by an array of light sources including the light source, the method comprising:
collimating unpolarized light emitted by each light source of the array of light sources using an array of lenses including the lens to obtain an array of collimated beams including the collimated beam;
propagating the collimated beams through the reflective polarizer to transmit first portions of the collimated beams in the first polarization state while reflecting second portions of the collimated beams in the second polarization state;
focusing the reflected second portions onto reflectors disposed proximate corresponding light sources of the array of light sources;
re-collimating the second portions reflected by the reflectors;
converting the polarization state of the second portions from the second to the first polarization state; and
transmitting the second portions in the first polarization state through the reflective polarizer.
